(19) United States
(12) Patent Application Publication
(10) Pub. No.: US 2016/0263661 A1
(43) Pub. Date: Sep. 15, 2016

(54) BORING MACHINE

(71) Applicant: Ju-Chuan Chien, Taipei (TW)

(72) Inventor: Feng -Wen Tseng, Taipei (TW)

(21) Appl. No.: 14/645,705

(22) Filed: Mar. 12, 2015

(51) Int. Cl. B23B 39/10; B23B 39/04

(52) U.S. Cl. CPC B23B 39/10; B23B 39/04; B23B 2260/07

(57) ABSTRACT

The present invention discloses a boring machine which includes a table, a headstock unit which is installed on the table, a drive unit which drives the headstock unit to displace linearly along a first axis, a seat and a power unit. The seat provides for combining the headstock unit with the drive unit. The drive unit drives the headstock unit to displace linearly along the first axis, the power unit drives the headstock unit to rotate, and the power unit changes rotational speed by using the gnawing relation among main gears and speed-change gears in different sizes, so that the headstock unit can shift to different speed to cope with all kinds of machine processing.

### BACKGROUND OF THE INVENTION

(a) Field of the Invention

The present invention relates to a boring machine, and more particularly to a boring machine with a headstock unit having a power design of shifting speed to high, medium or low gear, such that the boring machine can be used broadly in general machining.

(b) Description of the Prior Art

Machine equipment, especially a lathe, milling machine, boring machine, planing machine or grinding machine, has taken a leading role in all kinds of machine processing. Currently, a CNC (Computer Numerically Controlled) machine has shown up for the processing automation and the improvement of processing speed and precision. Among the abovementioned machine equipment, the milling machine is utilized to process planar parts and the boring machine is used primarily to perform precision machining for holes; the plane processing and the hole processing are often used in the machine processing.

For the ordinary boring machine, a motor is primarily used to drive a machining shaft to rotate in high speed, so as to lead a cutting tool that is connected to the machining shaft to implement a pre-determined processing procedure on a workpiece, thereby accomplishing the processing of the workpiece.

However, in an actual operation, this kind of processing machine does not perform the processing in a single mode on a single product; therefore, the processing tool should be replaced depending upon the object of processing and the processing procedure. In addition, the operating speed of the machining shaft will not be the same according to the object of processing and the processing procedure. Accordingly, the operation mode of machining shaft in single speed is unable to comply with the actual need of operation.

### SUMMARY OF THE INVENTION

Accordingly, the primary object of the present invention is to provide a boring machine with a headstock unit having a power design of shifting speed to high, medium or low gear, such that the boring machine can be used broadly in general machining.

To achieve the abovementioned object, the present invention discloses a boring machine which includes primarily a table, a headstock unit installed on the table, a drive unit that drives the headstock unit to displace linearly along a first axis, a seat, and a power unit. The seat provides for the combination of the headstock unit and the drive unit, enabling the drive unit to drive the headstock unit to displace linearly along the first axis. The power unit drives the headstock unit to rotate and changes the rotational speed by a gnawing relation among main gears and speed-change gears in various sizes, so that the headstock unit can rotate at different speed to cope with all kinds of machine processing.

Accordingly, the headstock unit of the present invention is provided with the power design of shifting speed to high, medium or low gear, such that the present invention can be used broadly in general machining. Therefore, the requirement of processing in high, medium or low speed can be satisfied at a same time with a single boring machine, and all kinds of machine processing can be dealt with.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional structural view of a boring machine of the present invention.

FIG. 2 shows a first schematic view of the boring machine of the present invention.

FIG. 3 shows a second schematic view of the boring machine of the present invention.

FIG. 4 shows a three-dimensional structural view of a power unit of the present invention.

FIG. 5 shows a first schematic view of the power unit of the present invention.

FIG. 6 shows a second schematic view of the power unit of the present invention.

### DETAILED DESCRIPTION OF THE PREFERRED EMBODIMENTS

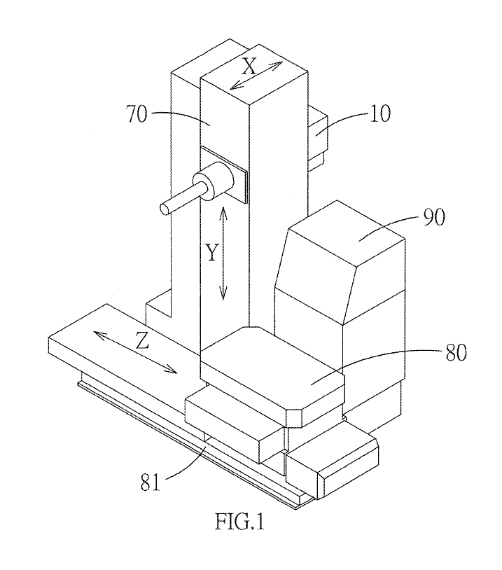

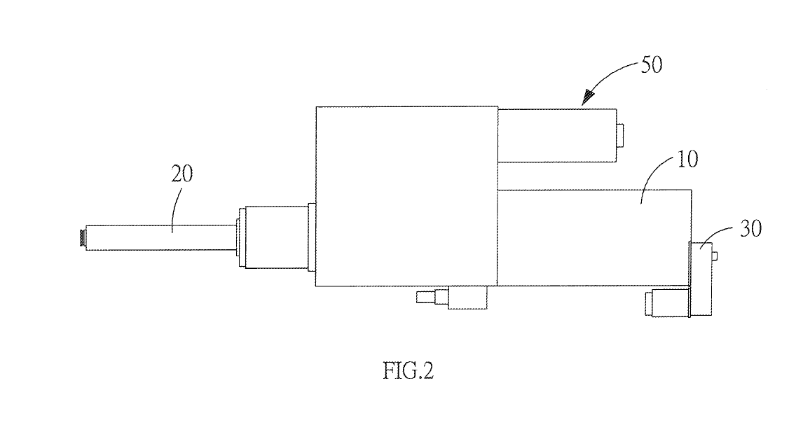

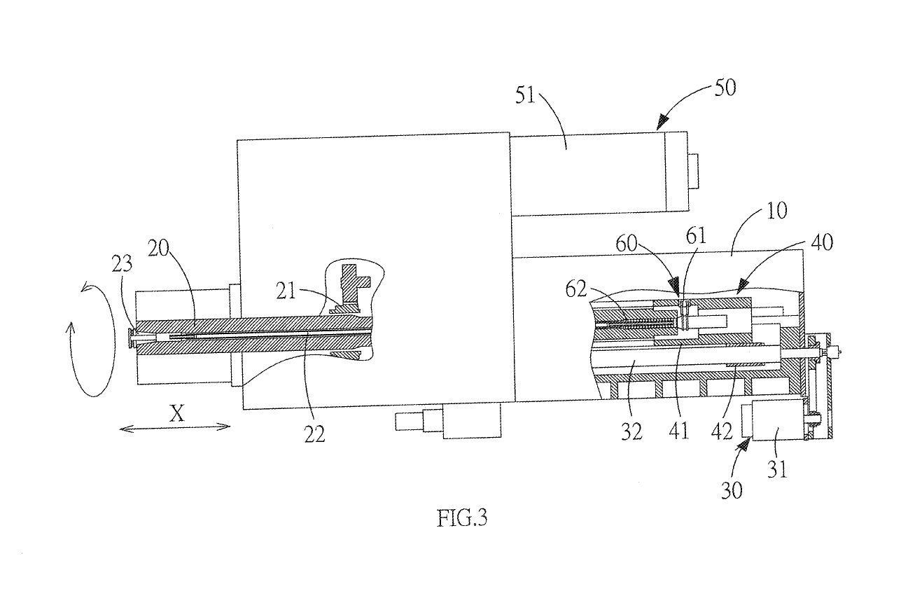

FIG. 1, FIG. 2, and FIG. 3 show a three-dimensional structural view of the boring machine, and a first schematic view and a second schematic view of the boring machine, according to the present invention. As shown in the drawings, the boring machine includes primarily a table 10, a headstock unit 20 installed on the table 10, a drive unit 30, a seat 40 and a power unit 50.

The headstock unit 20 is installed in the table 10 and is sheathed with at least a gnawing tooth member 21; a link rod 22 is sheathed inside the headstock unit 20 and a front end of the link rod 22 is provided with a blade barrel clip 23 which provides for clipping a blade (not shown in the drawings).

The drive unit 30 drives the headstock unit 20 to displace linearly along a first axis X, so that a processing blade can be fed in or discharged out of an end of the blade barrel clip 23 that clips the processing blade. The drive unit 30 is provided with a first power part 31 and a lead screw 32. The lead screw 32 is driven by the first power part 31 and is provided axially on the table 10. The first power part 31, for example, can be a motor which drives a belt, with the belt driving the lead screw 32 to rotate.

The seat 40 is provided with a fixing base 41 for installing and positioning the headstock unit 20, and an assembly part 42 which is connected at a bottom of the fixing base 41 and is assembled with the lead screw 32. In the present embodiment, the fixing base 41 can be a nut base and is installed at an end of the headstock unit 20 away from the blade barrel clip 23; whereas, the assembly part 42 can be a nut which is connected integrally with the nut base.

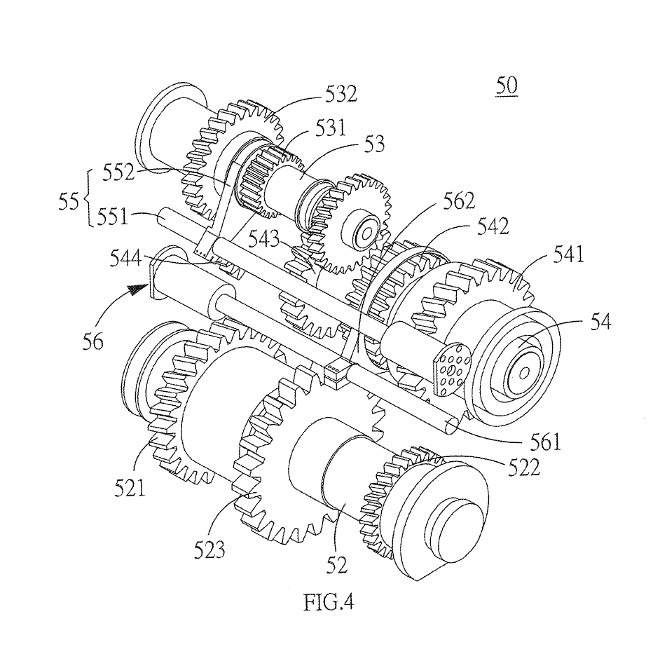

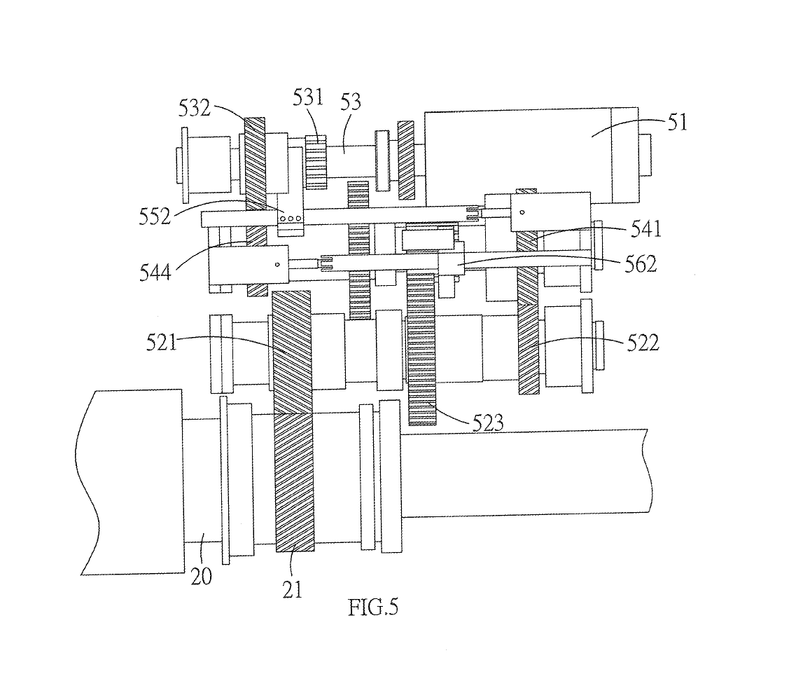

The power unit 50 drives the headstock unit 20 to rotate. Referring to FIG. 4 and FIG. 5 at a same time, the power unit 50 is provided with a second power part 51, a main shaft 52, at least a speed-change shaft and at least a lever set. The main shaft 52 is axially provided with a main driving wheel 521 and at least two main gears in different sizes. For the embodiment as shown in the drawings, the main shaft 52 is axially provided with a first main gear 522 and a second main gear 523. The main driving wheel 521 is gnawed with the gnawing tooth member 21. The power unit 50 is provided with a first speed-change shaft 53 and a second speed-change shaft 54. The first speed-change shaft 53 is provided with a first speed-change gear 531, and a second speed-change gear 532 which is not the same size as the first speed-change gear 531. For the embodiment as shown in the drawings, the first speed-change gear 531 is smaller than the second speed-change gear 532; that is, the number of tooth of the first speed-change gear 531 is less than the number of tooth of the second speed-change gear 532. The second speed-change shaft 54 is provided with a third speed-change gear 541, a fourth speed-change gear 542, a fifth speed-change gear 543, and a sixth speed-change gear 544. The third, fourth, fifth and sixth speed-change gears 541, 542, 543, 544 are not the same size. For the embodiment as shown in the drawings, the third speed-change gear 541 is larger than the fourth speed-change gear 542, the fourth speed-change gear 542 is larger than the fifth speed-change gear 543, and the fifth speed-change gear 543 is larger than the sixth speed-change gear 544; wherein, the second speed-change gear 532 of the first speed-change shaft 53 can be gnawed with the sixth speed-change gear 544, and the third speed-change gear 541 of the second speed-change shaft 54 can be gnawed with the first main gear 522.

The power unit 50 is provided with a first lever set 55 and a second lever set 56. The first lever set 55 is provided with a third power part (not shown in the drawings), a first shaft 551 driven by the third power part, and a first lever plate 552 which is sheathed at the first shaft 551 to lever the first speed-change shaft 53. The second lever set 56 is provided with a fourth power part (not shown in the drawings), a second shaft 561 driven by the fourth power part, and a second lever plate 562 which is sheathed at the second shaft 561 to lever the second speed-change shaft 54.

When the boring process is being performed, as shown in FIG. 3 and FIG. 5, the first power part 31 drives the lead screw 32 to rotate, the lead screw 32 drives the fixing base 41 and the assembly part 42 to move, and the fixing base 41 drives the headstock unit 20 to displace linearly along the first axis X, thereby implementing the boring process. Also when the boring process is being undertaken, the second power part 51 drives the first speed-change shaft 53 to rotate. At this time, the second speed-change gear 532 of the first speed-change shaft 53 is gnawed with the sixth speed-change gear 544, and the third speed-change gear 541 of the second speed-change shaft 54 is gnawed with the first main gear 522, so that power of the second power part 51 can be transmitted to the main shaft 52. Next, the main driving wheel 521 is engaged with the gnawing tooth member 21, so that the power of second power part 51 can drive the headstock unit 20 to rotate, thereby implementing the boring process.

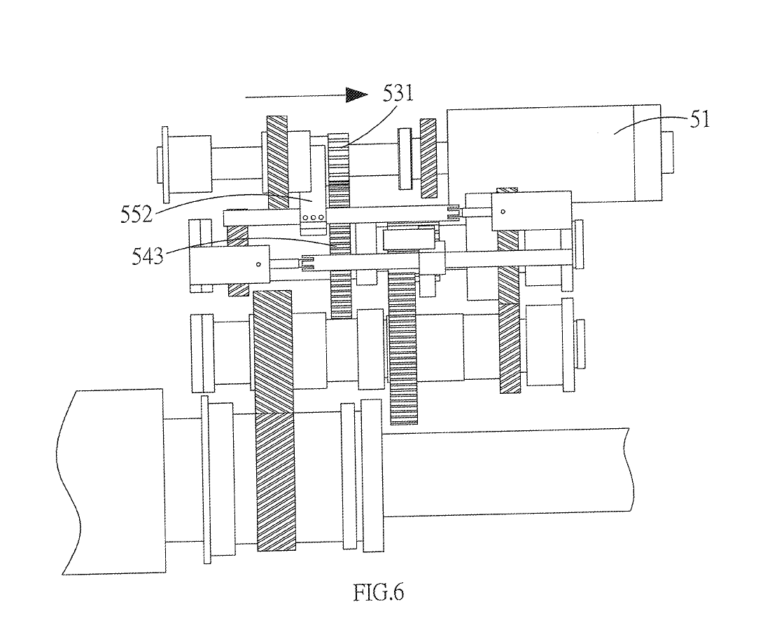

When the rotational speed is to be changed, the lever set can be used to lever one of the speed-change shafts to displace linearly along the first axis, so as to change the gnawing relation among the main gears and the speed-change gears, thereby arriving at the different rotational speed. For example, the first lever plate 552 levers the first speed-change shaft 53 to displace linearly along the first axis X to change to the gnawing between the second speed-change gear 532 and the sixth speed-change gear 544 (as shown in FIG. 5), or to the gnawing between the first speed-change gear 531 and the fifth speed-change gear 543 (as shown in FIG. 6). Therefore, different rotational speed can be obtained using the gnawing relation of the speed-change gears in different sizes. On the other hand, the second lever plate levers the second speed-change shaft to displace linearly along the first axis to change to the gnawing between the third speed-change gear and the first main gear, or to the gnawing between the fourth speed-change gear and the second speed-change gear. Using the gnawing relation between the first or second speed-change shaft and the main shaft of the power unit, the first and second lever sets can shift the rotational speed to at least three gears.

Moreover, the boring machine is further provided with a link device 60 which displaces the link rod 22 to drive the blade barrel clip 23 to protrude out of or retract into the headstock unit 20. As shown in FIG. 3, the link device 60 is provided with a push part 61 which pushes the link rod 22 to displace, driving the blade barrel clip 23 to protrude out of the headstock unit 20. The link device 60 also includes a compression spring 62 which pulls back the link rod 22 to displace, driving the blade barrel clip 23 to retract into the headstock unit 20. The push part 61 is a pneumatic rod or hydraulic rod. When the link rod 22 displaces to drive the blade barrel clip 23 to protrude out of the headstock unit 20, a processing blade can be released from clipping, and another processing blade can be put into the blade barrel clip 23 instead. Next, using the action of compression spring 62, the link rod 22 can displace to drive the blade barrel clip 23 to retract into the headstock unit 20, thereby enabling the blade barrel clip 23 to clip another processing blade to achieve an effect of replacing the processing blade automatically.

In addition, the table 10 is disposed in an upright column 70, as shown in FIG. 1. There are also a first drive assembly (not shown in the drawing) and a second drive assembly (not shown in the drawing). The first drive assembly drives the upright column 70 to displace linearly along the first axis X, and the second drive assembly drives the table 10 to displace linearly inside the upright column 70 along a second axis Y which is perpendicular to the first axis X. A work bed 80 is further disposed at a side of the upright column 70 to put an object to be processed. A third drive assembly 81 drives the work bed 80 to displace linearly along a third axis Z which is perpendicular to the first axis X and the second axis Y, respectively. A control assembly 90 is further provided and is connected respectively with the first drive assembly, the second drive assembly, the third drive assembly 81, the drive unit, the power unit and the link device (not shown in the drawing) to control the operation.

It is to be understood that the above description and drawings are only used for illustrating some embodiments of the present invention, not intended to limit the scope thereof. Any variation and deviation from the above description and drawings should be included in the scope of the present invention.

What is claimed is:

1. A boring machine comprising:
a table;
a headstock unit, wherein the headstock unit is installed on the table and is sheathed with a gnawing tooth member;
a drive unit, wherein the drive unit drives the headstock unit to displace linearly along a first axis, and is provided with a first power part and a lead screw which is driven by the first power part and is provided axially on the table;
a seat, wherein the seat is provided with a fixing base to install and position the headstock unit, and an assembly part which is connected at a bottom of the fixing base and is combined with the lead screw; and
a power unit, wherein the power unit drives the headstock unit to rotate, and is provided with a second power part, a main shaft, at least a speed-change shaft and at least a lever set, with the main shaft being axially provided with a main driving wheel and at least two main gears in different sizes, the main driving wheel being gnawed with the gnawing tooth member, the speed-change shaft being axially provided with two speed-change gears in different sizes, the second power part driving one speed-change gear to rotate, the lever set levering the speed-change shaft to displace linearly along the first axis to change the gnawing relation among the main gears and the speed-change gears.

2. The boring machine according to claim 1, wherein the power unit is provided with a first speed-change shaft and a second speed-change shaft, with the first speed-change shaft being provided with a first speed-change gear and a second speed-change gear, the second speed-change shaft being provided with a third speed-change gear, a fourth speed-change gear, a fifth speed-change gear and a sixth speed-change gear, and the main shaft being axially provided with a first main gear and a second main gear.

3. The boring machine according to claim 2, wherein the power unit is provided with a first lever set and a second lever set, with the first lever set being provided with a third power part, a first shaft being driven by the third power part, and a first lever plate being sheathed at the first shaft to lever the first speed-change shaft, and the second lever set being provided with a fourth power part, a second shaft being driven by the fourth power part, and a second lever plate being sheathed at the second shaft to lever the second speed-change shaft.

4. The boring machine according to claim 3, wherein the first lever plate levers the first speed-change shaft to displace linearly along the first axis to change to a gnawing between the first speed-change gear and the fifth speed-change gear or to the gnawing between the second speed-change gear and the sixth speed-change gear, or the second lever plate levers the second speed-change shaft to displace linearly along the first axis to change to the gnawing between the third speed-change gear and the first main gear, or to the gnawing between the fourth speed-change gear and the second speed-change gear.

5. The boring machine according to claim 1, wherein a link rod is sheathed inside the headstock unit and a front end of the link rod is provided with a blade barrel clip, with the boring machine being further provided with a link device which displaces the link rod to drive the blade barrel clip to protrude out of or retract into the headstock unit.

6. The boring machine according to claim 5, wherein the link device is provided with a push part which pushes the link rod to displace to drive the blade barrel clip to protrude out of the headstock unit, and a compression spring which pulls back the link rod to displace to drive the blade barrel clip to retract into the headstock unit.

7. The boring machine according to claim 5, wherein the table is disposed in an upright column, with the boring machine further including a first drive assembly and a second drive assembly, the first drive assembly driving the upright column to displace linearly along the first axis, and the second drive assembly driving the table to displace linearly inside the upright column along a second axis which is perpendicular to the first axis.

8. The boring machine according to claim 7, further including a work bed which is disposed at a side of the upright column, and a third drive assembly which drives the work bed to displace linearly along a third axis.

9. The boring machine according to claim 8, further including a control assembly which is connected respectively with the first drive assembly, the second drive assembly, the third drive assembly, the drive unit, the power unit and the link device to control the operation.

10. A boring machine comprising:
a table;
a headstock unit, wherein the headstock unit is installed on the table and is sheathed with a gnawing tooth member, with a link rod being sheathed inside the headstock unit and a front end of the link rod being provided with a blade barrel clip;
a link device, wherein the link device is provided with a push part which pushes the link rod to displace to drive the blade barrel clip to protrude out of the headstock unit, and a compression spring which pulls back the link rod to displace to drive the blade barrel clip to retract into the headstock unit, with the compression spring driving the link rod to displace to drive the blade barrel clip to protrude out of or retract into the headstock unit;
a drive unit, wherein the drive unit drives the headstock unit to displace linearly along a first axis, and is provided with a first power part and a lead screw which is driven by the first power part and is axially disposed at the table;
a seat, wherein the seat is provided with a fixing base to install and position the headstock unit, and an assembly part which is connected at a bottom of the fixing base and is combined with the lead screw;
a power unit, wherein the power unit drives the headstock unit to rotate, and is provided with a second power part, a main shaft, at least a speed-change shaft and at least a lever set, with the main shaft being axially provided with a main driving wheel and at least two main gears in different sizes, the main driving wheel being gnawed with the gnawing tooth member, the speed-change shaft being axially provided with two speed-change gears in different sizes, the second power part driving one speed-change shaft to rotate, the lever set levering the speed-change shaft to displace linearly along the first axis to change the gnawing relation among the main gears and the speed-change gears;
an upright column, wherein the upright column provides for containing the table;
a first drive assembly, wherein the first drive assembly drives the upright column to displace linearly along a first axis;
a second drive assembly, wherein the second drive assembly drives the table to displace linearly inside the upright column along a second axis which is perpendicular to the first axis;
a work bed, wherein the work bed is disposed at a side of the upright column; and
a third drive assembly, wherein the third drive assembly drives the work bed to displace linearly along a third axis.
